(19) United States
(12) Patent Application Publication
(10) Pub. No.: US 2021/0218004 A1
(43) Pub. Date: Jul. 15, 2021

(54) BATTERY FIRE SUPPRESSION SYSTEM

(71) Applicant: Caterpillar Inc., Peoria, IL (US)

(72) Inventors: Eric A. MORR, Chillicothe, IL (US); Justin D. MIDDLETON, Peoria, IL (US)

(73) Assignee: Caterpillar Inc., Peoria, IL (US)

(21) Appl. No.: 16/740,033

(22) Filed: Jan. 10, 2020

(51) Int. Cl. H01M 2/12; H01M 2/10

(52) U.S. Cl. CPC H01M 2/127; H01M 2/1077

(57) ABSTRACT

A battery pack is disclosed. The battery pack may include a battery pack housing having an exterior surface. The battery pack may include one or more battery cells positioned within the battery pack housing. The battery pack may include one or more pipes having openings, wherein the one or more pipes are positioned within the battery pack housing to provide, through the openings, a fluid onto the one or more battery cells. The battery pack may include a port positioned in the exterior surface of the battery pack housing, wherein the port is in fluid connection with the one or more pipes.

### TECHNICAL FIELD

The present disclosure relates generally to battery packs and, for example, to a battery pack having a battery fire suppression system.

### BACKGROUND

A machine may include one or more battery packs to provide power to components of the machine, such as lights, computer systems, an engine, and/or the like. For example, a machine may include a battery pack having multiple battery cells, and the battery cells may include flammable chemicals. The battery pack may include a housing of metal shielding to protect the battery cells. The battery pack may include a cooling mechanism (e.g., one or more airducts, one or more coolant ducts, and/or the like) to prevent the battery cells from overheating. However, the cooling mechanism may not provide enough cooling to one of the battery cells, and the battery cell may overheat and ignite. When one battery cell ignites and begins burning, the heat from the burning battery cell may ignite other adjacent battery cells, such that the fire cascades through the battery pack.

FIG. 1 is a diagram of an example battery pack 100 without a battery fire suppression system. As shown in FIG. 1, the battery pack 100 may include battery pack housing 101, strings 102, battery modules 103, and battery cells 104. As shown, the strings 102 may include multiple battery modules 103, and the battery modules 103 may each include multiple battery cells 104. The strings 102 of battery modules 103 having battery cells 104 may be positioned within the battery pack housing 101.

As shown in FIG. 1, one or more battery cells 104 within the battery pack 100 may ignite and cause a fire within the battery pack housing 101. Heat from the fire may ignite other battery cells 104 and/or other battery modules 103 in the same string 102 and/or other strings 102. In this way, the fire may spread within the battery pack housing 101 and may damage and/or spread to other parts of a machine in which the battery pack 100 is positioned.

As also shown in FIG. 1, upon detecting the fire within the battery pack 100, fluid may be sprayed or pumped onto the battery pack 100 (e.g., by a firefighter, by an operator of the machine, and/or the like). However, the battery pack housing 101 may prevent the fluid from penetrating within the battery pack housing 101. The fluid may not extinguish the fire within the battery pack housing 101, and the fire may continue to spread within the battery pack housing 101 and ignite other battery cells 104. Thus, the fire within the battery pack 100 may destroy all the battery cells 104 and may damage the machine in which the battery pack 100 is positioned.

One attempt to suppress fires within a battery pack is disclosed in International Publication No. WO 2014/077536 by the Korean Automotive Technology Institute (the '536 publication). In particular, the '536 publication discloses a system including a temperature sensing unit, a control portion, pumps, valves, and a supply pipe having nozzles to inject a neutralizing agent, from a neutralizing agent tank, into battery cells. The control portion may cause the valve to open and cause the pump to drive the neutralizing agent to the supply pipe, which injects the neutralizing agent into the battery cells.

While the system of the '536 publication may be able to suppress a fire within a battery pack, the system requires many elements, such as the temperature sensing unit, the control portion, the pumps, the valves, the supply pipe, and the neutralizing agent tank, which may increase the cost of the battery pack and/or the machine in which the battery pack is installed. Additionally, installing the system on a machine may be difficult due to identifying a location on the machine for the neutralizing agent tank, supplying power to the control portion, routing the supply pipe from the neutralizing agent tank to the battery pack and to the battery cells, and/or the like. Furthermore, depending on a work environment of the machine, these elements may require additional protection, such as steel plating and/or the like, to prevent them from being damaged. The system of the '536 publication may also require additional maintenance, testing, and/or the like to confirm that the neutralizing agent has not expired or otherwise become ineffective, that the supply pipe is still properly connected, that the temperature sensing unit, the control portion, the pumps, the valves function properly. Moreover, the neutralizing agent tank may only contain a fixed amount of neutralizing agent, and, in some circumstances, that fixed amount of neutralizing agent may be insufficient to extinguish a fire within the battery pack.

The battery pack of the present disclosure solves one or more of the problems set forth above and/or other problems in the art.

### SUMMARY

According to some implementations, a battery pack may include a battery pack housing having an exterior surface; one or more battery cells positioned within the battery pack housing; one or more pipes having openings, wherein the one or more pipes are positioned within the battery pack housing to provide, through the openings, a fluid onto the one or more battery cells; and a port positioned in the exterior surface of the battery pack housing, wherein the port is in fluid connection with the one or more pipes.

According to some implementations, a method may include receiving, by a battery pack, via a port positioned in an exterior surface of a battery pack housing, a fluid; providing, by the battery pack, via the port, the fluid to one or more pipes positioned within the battery pack housing; and providing, by the battery pack, via openings in the one or more pipes, the fluid onto one or more battery cells positioned within the battery pack housing.

According to some implementations, a machine may include one or more components, and a battery pack to provide power to the one or more components, wherein the battery pack includes: a battery pack housing having an exterior surface, one or more battery modules positioned within the battery pack housing, wherein each of the one or more battery modules includes a module housing and one or more battery cells positioned within the module housing, one or more pipes having openings, wherein the one or more pipes are positioned within the battery pack housing to provide, through the openings, a fluid onto the one or more battery modules, and a port positioned in the exterior surface of the battery pack housing, wherein the port is in fluid connection with the one or more pipes.

### BRIEF DESCRIPTION OF THE DRAWINGS

FIG. 1 is a diagram of an example battery pack without a battery fire suppression system.

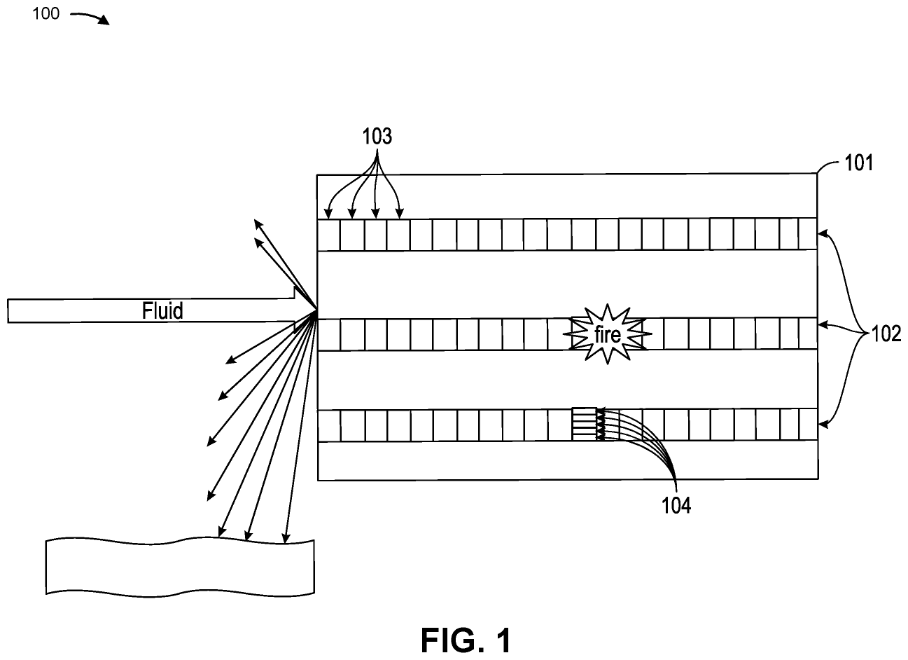

FIG. 2 is a diagram of an example battery pack having a battery fire suppression system.

FIG. 3 is a diagram of an example machine that may include a battery pack having a battery fire suppression system.

FIG. 4 is a diagram of an example system of multiple battery packs having battery fire suppression systems.

FIG. 5 is a flow chart of an example process for suppressing a fire in a battery pack.

### DETAILED DESCRIPTION

This disclosure relates to a battery pack. The battery pack has universal applicability to any machine utilizing such a battery pack. The term “machine” may refer to any machine that performs an operation associated with an industry such as, for example, mining, construction, farming, transportation, or any other industry. As some examples, the machine may be an underground machine, a surface machine, an off-road machine, an on-road machine, a vehicle, a backhoe loader, a cold planer, a wheel loader, a compactor, a feller buncher, a forest machine, a forwarder, a harvester, an excavator, an industrial loader, a knuckleboom loader, a material handler, a motor grader, a pipelayer, a road reclaimer, a skid steer loader, a skidder, a telehandler, a tractor, a dozer, a tractor scraper, or other above ground equipment, underground equipment, or marine equipment. Moreover, one or more implements may be connected to the machine and driven from the battery pack.

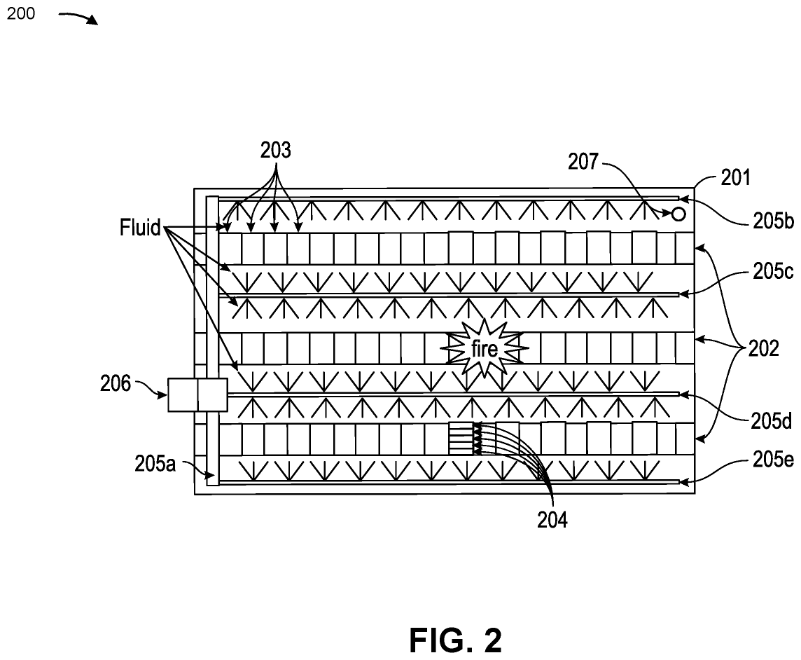

FIG. 2 is a diagram of an example battery pack 200 having a battery fire suppression system. Example battery pack 200 may include a battery pack housing 201, strings 202, battery modules 203, battery cells 204, pipes 205a, 205b, 205c, 205d, and 205e (collectively referred to herein as pipes 205), port 206, and vent 207. Battery pack housing 201 may include metal shielding (e.g., steel, aluminum, and/or the like) to protect elements (e.g., strings 202, battery modules 203, battery cells 204, pipes 205, wires, circuit boards, cooling systems, and/or the like) positioned within battery pack housing 201. Each of battery modules 203 may include one or more battery cells 204 (e.g., positioned within a module housing and/or the like). Each of strings 202 may include one or more battery modules 203 (e.g., positioned adjacent to each other on a tray and/or the like).

The battery fire suppression system of example battery pack 200 may include pipes 205, port 206, and vent 207. As shown in FIG. 2, pipes 205 may have openings, and pipes 205 and/or the openings may be positioned within battery pack housing 201 to provide, through the openings, a fluid onto strings 202, battery modules 203, and/or battery cells 204. By providing fluid onto strings 202, battery modules 203, and/or battery cells 204, pipes 205 may cool strings 202, battery modules 203, and/or battery cells 204 that are not on fire, prevent strings 202, battery modules 203, and/or battery cells 204 that are not on fire from igniting, extinguish the fire, and/or the like. Pipes 205 may be positioned between an interior surface of battery pack housing 201 and at least one of strings 202 (e.g., as shown in FIG. 2 by pipe 205b and pipe 205e in battery pack housing 201), positioned between adjacent strings 202 (e.g., as shown in FIG. 2 by pipe 205c and pipe 205d in battery pack housing 201), and/or the like.

Pipes 205 may be positioned within battery pack housing 201 to provide, through the openings, fluid to voids (e.g., spaces between strings 202, battery modules 203, battery cells 204, and/or the like) within battery pack housing 201. By providing fluid to voids within battery pack housing 201, pipes 205 may remove oxygen, which the fire may require to burn, from within battery pack housing 201, thereby extinguishing the fire, preventing strings 202, battery modules 203, and/or battery cells 204 that are not on fire from igniting, and/or the like.

As shown in FIG. 2 by pipe 205c and pipe 205d, pipes 205 may have openings positioned to direct fluid in multiple directions. Pipes 205 may include nozzles positioned with the openings. Pipes 205 may be made of metal (e.g., steel, aluminum, and/or the like), a flame-resistant material, and/or the like, and may have any suitable shape of cross-section (e.g., a circular cross-section, an ovular cross-section, a rectangular cross-section, a triangular cross-section, and/or the like). Pipes 205 may be passageways constructed within an interior of battery pack housing 201. Although one vertical pipe 205a and four horizontal pipes 205b, 205c, 205d, and 205e are shown in example battery pack 200 of FIG. 2, other example battery packs may include one pipe 205 or any number of pipes 205. Example battery packs may include pipes 205 that extend horizontally, vertically, diagonally, and/or the like within battery pack housing 201, pipes 205 that curve, pipes 205 that include one or more bends, and/or the like.

Port 206 may be positioned in an exterior surface of battery pack housing 201. As shown in FIG. 2, port 206 may be in fluid connection with pipes 205 such that, when fluid is supplied to an external portion of port 206 (e.g., a portion of port 206 on the exterior surface of battery pack housing 201 and/or the like), port 206 provides fluid to pipes 205 (e.g., via vertical pipe 205a). Port 206 may include a fire department connection (FDC), a national pipe thread (NPT) port, and/or the like. Port 206 may provide, on the exterior surface of battery pack housing 201, a connection to pipes 205. Port 206 may be positioned in any exterior surface of battery pack housing 201, such as a sidewall (as shown in FIG. 2), a top wall, a bottom wall, and/or the like. Although one port 206 is shown in example battery pack 200 of FIG. 2, other example battery packs may include any number of ports.

Vent 207 may be an opening, an opening with a friction-fit cap, a pressure-based vent, and/or the like. For example, vent 207 may open, based on pressure within battery pack housing 201 satisfying a threshold, to reduce the pressure within battery pack housing 201 (e.g., by permitting gasses and/or liquids to exit battery pack housing 201 and/or the like). For example, as fluid is supplied to the interior of battery pack housing 201 (e.g., by port 206 and pipes 205), pressure within battery pack housing 201 may increase (e.g., due to fluid heating and turning into steam, due to an increase in contents of battery pack housing 201, and/or the like). If pressure within battery pack housing 201 exceeds a threshold, the battery pack housing 201 may fail resulting in an explosion that may damage battery pack 200, damage a machine in which battery pack 200 is installed, damage a structure, machine, equipment, and/or the like near battery pack 200, injure an operator, firefighter, and/or the like near battery pack 200, and/or the like.

Vent 207 may close, based on the pressure within battery pack housing 201 not satisfying the threshold, to seal battery pack housing 201 (e.g., to prevent chemicals, gases, and/or the like within battery pack housing 201 from leaking). Vent 207 may be manually opened and/or manually closed (e.g., in case of malfunction). Vent 207 may be positioned in any exterior surface of battery pack housing 201, such as a sidewall (as shown in FIG. 2), a top wall, a bottom wall, and/or the like. Although one vent 207 is shown in example battery pack 200 of FIG. 2, other example battery packs may include any number of vents.

As indicated above, FIG. 2 is provided as an example. Other examples may differ from what is described in connection with FIG. 2.

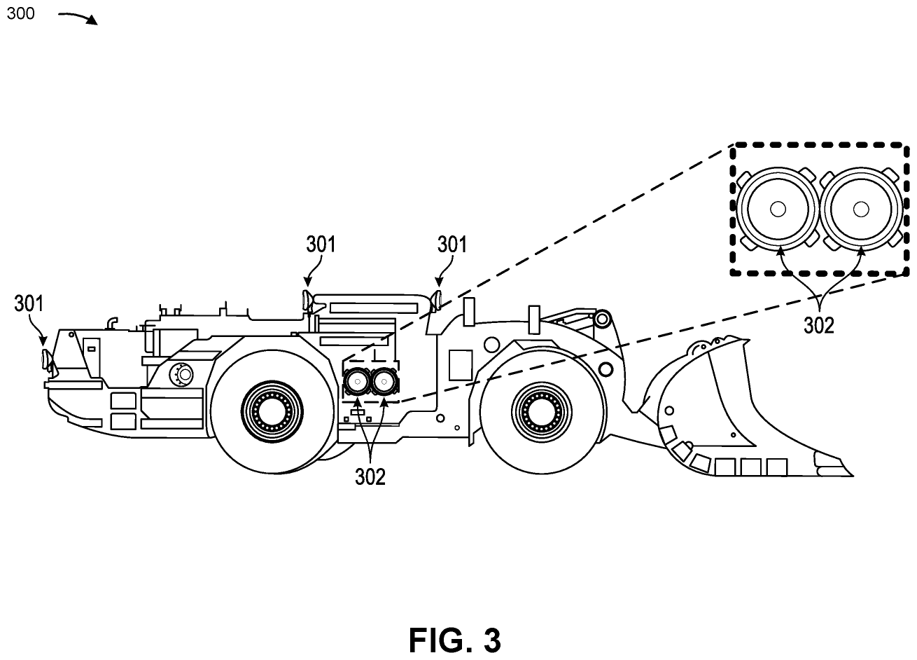

FIG. 3 is a diagram of an example machine 300 that may include a battery pack having a battery fire suppression system. Machine 300 may include one or more components, such as lights 301, and one or more battery packs to provide power to the one or more components. For example, the one or more battery packs may be similar to example battery pack 200 described with respect to FIG. 2.

As shown in FIG. 3, machine 300 may include exterior ports 302 positioned on an exterior surface of machine 300. Exterior ports 302 may be used to provide fluid to the one or more battery packs to extinguish a fire, to prevent a fire within one of the one or more battery packs from spreading to another battery pack, to prevent one or more battery cells within the one or more battery packs from overheating, and/or the like. Exterior ports 302 may include an FDC, an NPT port, and/or the like. Each of exterior ports 302 may correspond to a port of the one or more battery packs. For example, machine 300 may include two battery packs similar to example battery pack 200 as shown in FIG. 2, and the exterior surface of battery pack housing 201 in which port 206 is positioned may form a portion of the exterior surface of machine 300, such that each port 206 of the battery packs forms an exterior port 302 of the machine 300.

Additionally, or alternatively, exterior ports 302 may be in fluid connection with one or more ports of the one or more battery packs (e.g., via an internal pipe, via a hose, and/or the like). For example, machine 300 may include a first battery pack having a first port, a second battery pack having a second port, a first exterior port (e.g., of exterior ports 302), and a second exterior port (e.g., of exterior ports 302). The first exterior port may be in fluid connection with the first port such that fluid supplied to the first exterior port is provided to the first port, which provides the fluid to an interior of the first battery pack. Similarly, the second exterior port may be in fluid connection with the second port such that fluid supplied to the second exterior port is provided to the second port, which provides the fluid to an interior of the second battery pack. Thus, fluid may be supplied to the first battery pack, the second battery pack, or both the first battery pack and the second battery pack, by supplying fluid to the first exterior port, the second exterior port, or both the first exterior port and the second exterior port, respectively. In this way, an operator, firefighter, and/or the like may select which battery pack to provide with fluid (e.g., based on knowledge of a location of the fire (e.g., within the first battery pack, within the second battery pack, and/or the like) and/or the like) and not provide fluid to a battery pack in which there is not a fire, thereby conserving resources that would otherwise be consumed by repairing, refurbishing, and/or the like damage caused by fluid in the battery pack in which there is not a fire.

In another example, machine 300 may include a first battery pack having a first port, a second battery pack having a second port, a first exterior port (e.g., of exterior ports 302), and a second exterior port (e.g., of exterior ports 302). The first exterior port and the second exterior port may be located on opposite sides of machine 300, such that an operator, firefighter, and/or the like may access at least one of the first exterior port or the second exterior port if a side of machine 300 is blocked (e.g., due to machine 300 being positioned adjacent a wall, another machine, a structure, and/or the like, due to machine 300 having tipped over, and/or the like). The first exterior port may be in fluid connection with the first port and the second port such that fluid supplied to the first exterior port is provided to the first port and the second port, which provide the fluid to interiors of the first battery pack and the second battery pack. Similarly, the second exterior port may be in fluid connection with the first port and the second port such that fluid supplied to the second exterior port is provided to the first port and the second port, which provide the fluid to interiors of the first battery pack and the second battery pack. In this way, an operator, firefighter, and/or the like may supply fluid to the first battery pack and the second battery pack even if access to a side of machine 300 is blocked.

As indicated above, FIG. 3 is provided as an example. Other examples may differ from what is described in connection with FIG. 3.

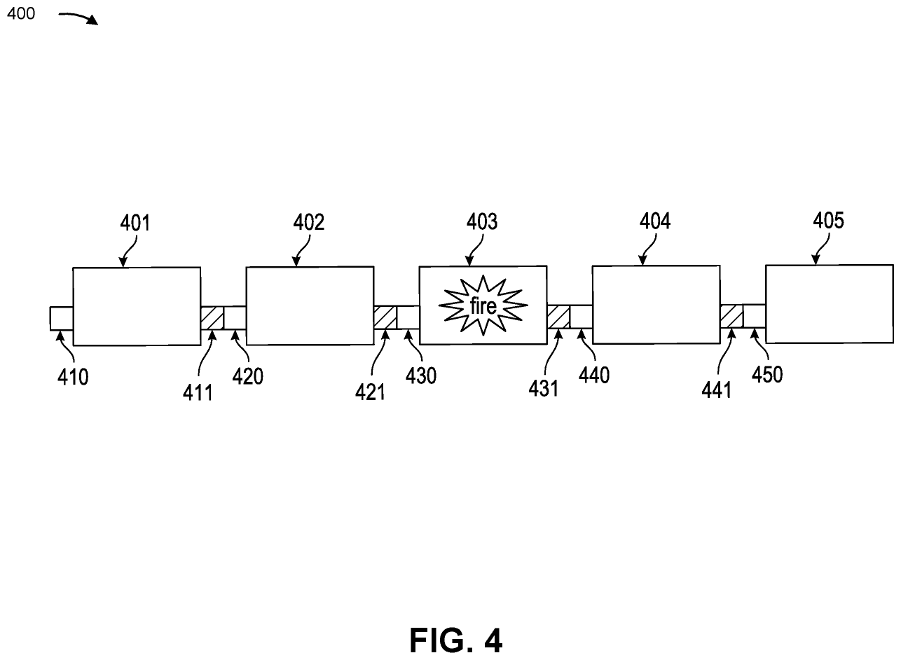

FIG. 4 is a diagram of an example system 400 of multiple battery packs having battery fire suppression systems. As shown in FIG. 4, example system 400 may include battery pack 401, battery pack 402, battery pack 403, battery pack 404, and battery pack 405. Although example system 400 includes five battery packs, other systems may include any number of battery packs. Battery pack 401, battery pack 402, battery pack 403, battery pack 404, and battery pack 405 may be similar to example battery pack 200 described with respect to FIG. 2. Example system 400 may be positioned within a machine, such as example machine 300 as shown in FIG. 3, and may provide power to one or more components of the machine.

As shown in FIG. 4, each of the battery packs 401, 402, 403, 404, and 405 may include a port 410, 420, 430, 440, and 450, respectively. For example, ports 410, 420, 430, 440, and 450 may be similar to port 206 of example battery pack 200 described with respect to FIG. 2.

As shown in FIG. 4, each of battery packs 401, 402, 403, and 404 may include an exit port 411, 421, 431, and 441, respectively. Each of the exit ports 411, 421, 431, and 441 may be in fluid communication with a port of another battery pack. When fluid is supplied to port 410, battery packs 401, 402, 403, and 404 may receive fluid via ports 410, 420, 430, 440, and 450, respectively and may provide fluid to battery packs 402, 403, 404, and 405 via exit ports 411, 421, 431, and 441, respectively.

For example, and as shown in FIG. 4, exit port 411 of battery pack 401 may be in fluid communication with port 420 of battery pack 402, and exit port 421 of battery pack 402 may be in fluid communication with port 430 of battery pack 403. When fluid is supplied to port 410, battery pack 401 may provide, via exit port 411, fluid to port 420 of battery pack 402, and battery pack 402, may provide, via exit port 421, fluid to port 430 of battery pack 403.

Each of the exit ports 411, 421, 431, and 441 may be in fluid communication with a port of another battery pack via a pipe, a hose, a mechanical connection, and/or the like. For example, battery pack 401 and battery pack 402 may have exterior surfaces configured such that, when battery pack 401 and battery pack 402 are positioned adjacent to each other, exit port 411 mechanically connects to port 420 (e.g., exit port 411 includes an opening into which port 420 inserts, exit port 411 includes a male mechanical connector and port 420 includes a corresponding female mechanical connector, and/or the like).

As shown in FIG. 4, battery pack 403 may contain a fire. System 400 may be positioned within a machine such that accessing battery pack 403 requires removing one or more other battery packs, requires removing one or more other systems of the machine, requires specialized equipment, and/or the like. System 400 may also be positioned within the machine such that port 410 of battery pack 401 may be supplied with fluid from the exterior of the machine (e.g., via a supply pipe, via a hose, via an exterior port, and/or the like). Because each of the exit ports 411, 421, 431, and 441 are in fluid communication with ports 410, 420, 430, 440, and 450, respectively, an operator, firefighter, and/or the like may supply fluid to port 410 of battery pack 401 to extinguish the fire in battery pack 403, cool interiors of battery packs 401, 402, 403, 404, and 405, prevent strings, battery modules, and/or battery cells within battery packs 401, 402, 403, 404, and 405 that are not on fire from igniting, and/or the like.

As indicated above, FIG. 4 is provided as an example. Other examples may differ from what is described in connection with FIG. 4.

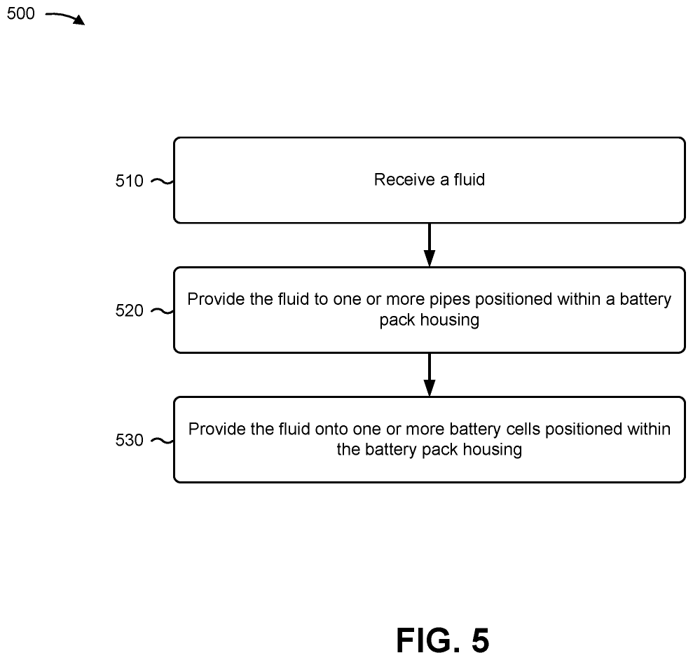

FIG. 5 is a flow chart of an example process 500 for suppressing a fire in a battery pack. In some implementations, one or more process blocks of FIG. 5 may be performed by a battery pack (e.g., battery pack 200), a battery pack housing (e.g., battery pack housing 201), and/or the like. In some implementations, one or more process blocks of FIG. 5 may be performed by another device or a group of devices separate from or including the battery pack, such as a machine (e.g., machine 300), a system (e.g., system 400), and/or the like.

As shown in FIG. 5, process 500 may include receiving a fluid (block 510). For example, the battery pack (e.g., using a port positioned in an exterior surface of a battery pack housing, such as port 206, and/or the like) may receive a fluid, as described above. Process 500 may include receiving the fluid from a hose connected to a port, a supply pipe connected to a port, a pump, a gravity feed, and/or the like. The fluid may include water, nitrogen, a fire suppressing agent, a foam, a mixture of water and soil, and/or the like. Process 500 may include receiving the fluid until the fluid fills voids within a battery pack housing.

As further shown in FIG. 5, process 500 may include providing the fluid to one or more pipes positioned within a battery pack housing (block 520). For example, the battery pack (e.g., using a port positioned in an exterior surface of the battery pack housing, such as port 206, and/or the like) may provide the fluid to one or more pipes positioned within the battery pack housing, as described above.

As further shown in FIG. 5, process 500 may include providing the fluid onto one or more battery cells positioned within the battery pack housing (block 530). For example, the battery pack (e.g., using openings in one or more pipes, such as pipes 205, positioned within the battery pack housing, and/or the like) may provide the fluid onto one or more battery cells positioned within the battery pack housing, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### INDUSTRIAL APPLICABILITY

A machine may include one or more battery packs (e.g., one or more battery packs similar to battery pack 200) in which one or more fires are burning. For example, as shown in FIG. 2, one or more battery cells 204 in the middle string of strings 202 of battery pack 200 may begin burning (e.g., due to overheating, a chemical leak, and/or the like) and create a fire within battery pack housing 201. The one or more battery packs may include a port in fluid connection with pipes positioned within the battery pack housing, where the pipes have openings to provide fluid onto strings, battery modules, and/or battery cells within the battery pack housing. The port may be positioned on an exterior surface of the machine such that fluid may be provided to the port from the exterior of the machine. Additionally, or alternatively, exterior ports may be positioned on the exterior surface of the machine and may be in fluid communication (e.g., via a pipe, a hose, and/or the like) with the port such that fluid may be provided to the exterior ports, which is then provided to the port of the battery pack.

Upon detecting the fire (e.g., by a sensor, by observing smoke, and/or the like), fluid may be supplied to the port. For example, a firefighter and/or emergency response person may connect a hose to the port and supply water as the fluid (e.g., using a pump and/or the like). Additionally, or alternatively, the fluid may be supplied to the port via a gravity feed (e.g., the port may be positioned in a top wall of the battery pack housing and fluid may be supplied by a bucket to the port, a hose may be connected to the port and fluid may be gravity fed via the hose to the port, and/or the like). In this way, an operator, firefighter, and/or the like may supply fluid to the interior of the one or more battery packs (e.g., without opening a battery pack housing, without removing parts of the machine, and/or the like). This allows the fluid to extinguish the fire, to prevent a fire within one of the one or more battery packs from spreading to another battery pack, to prevent one or more battery cells within the one or more battery packs from overheating, and/or the like.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations may be made in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

What is claimed is:

1. A battery pack, comprising:
a battery pack housing having an exterior surface;
one or more battery cells positioned within the battery pack housing,
one or more pipes having openings,
wherein the one or more pipes are positioned within the battery pack housing to provide, through the openings, a fluid onto the one or more battery cells; and
a port positioned in the exterior surface of the battery pack housing,
wherein the port is in fluid connection with the one or more pipes.

2. The battery pack of claim 1, further comprising:
one or more battery modules positioned within the battery pack housing,
wherein each of the one or more battery modules includes a module housing and at least one battery cell of the one or more battery cells positioned within the module housing; and
wherein the one or more pipes are positioned within the battery pack housing to provide, through the openings, the fluid onto the one or more battery modules.

3. The battery pack of claim 2, further comprising:
one or more strings positioned within the battery pack housing,
wherein each of the one or more strings includes a tray to hold at least two of the one or more battery modules adjacent to each other.

4. The battery pack of claim 3, wherein at least one of the one or more pipes is at least one of:
positioned between an interior surface of the battery pack housing and at least one of the one or more strings; or
positioned between adjacent strings of the one or more strings.

5. The battery pack of claim 1, further comprising:
a pipe, of the one or more pipes, having openings positioned to direct the fluid out of the pipe in multiple directions.

6. The battery pack of claim 1, further comprising:
nozzles positioned within the openings.

7. The battery pack of claim 1, wherein the one or more pipes are positioned within the battery pack housing to provide, through the openings, the fluid to voids within the battery pack housing.

8. A method, comprising:
receiving, by a battery pack, via a port positioned in an exterior surface of a battery pack housing, a fluid;
providing, by the battery pack, via the port, the fluid to one or more pipes positioned within the battery pack housing; and
providing, by the battery pack, via openings in the one or more pipes, the fluid onto one or more battery cells positioned within the battery pack housing.

9. The method of claim 8, wherein receiving the fluid comprises receiving the fluid from at least one of a hose connected to the port or a supply pipe connected to the port.

10. The method of claim 8, wherein the fluid includes at least one of: water, nitrogen, a fire suppressing agent, a foam, or a mixture of water and soil.

11. The method of claim 8, wherein receiving the fluid comprises receiving the fluid from at least one of a pump or a gravity feed.

12. The method of claim 8, further comprising:
receiving the fluid until the fluid fills voids within the battery pack housing.

13. A machine, comprising:
one or more components; and
a battery pack to provide power to the one or more components,
wherein the battery pack includes:
a battery pack housing having an exterior surface,
one or more battery modules positioned within the battery pack housing,
wherein each of the one or more battery modules includes a module housing and one or more battery cells positioned within the module housing,
one or more pipes having openings,
wherein the one or more pipes are positioned within the battery pack housing to provide, through the openings, a fluid onto the one or more battery modules, and
a port positioned in the exterior surface of the battery pack housing,
wherein the port is in fluid connection with the one or more pipes.

14. The machine of claim 13, wherein the machine is at least one of: an underground machine, a surface machine, an off-road machine, or an on-road machine.

15. The machine of claim 13, wherein the exterior surface of the battery pack housing in which the port is positioned is located on an exterior surface of the machine.

16. The machine of claim 13, further comprising:
an exterior port positioned on an exterior surface of the machine,
wherein the exterior port is in fluid connection with the port of the battery pack.

17. The machine of claim 16, further comprising:
an internal pipe to provide the fluid from the exterior port to the port of the battery pack.

18. The machine of claim 13, wherein the battery pack is a first battery pack and the port is a first port, and wherein the machine further comprises:
a second battery pack, including:
a second battery pack housing having a second exterior surface,
second battery modules positioned within the second battery pack housing,
second pipes having second openings, wherein the second pipes are positioned within the second battery pack housing to provide, through the second openings, the fluid onto the second battery modules, and
a second port positioned in the second exterior surface of the second battery pack housing, wherein the second port is in fluid connection with the second pipes.

19. The machine of claim 18, wherein the machine further comprises at least one of:
an exterior port in fluid connection with the first port of the first battery pack and the second port of the second battery pack; or
a first exterior port in fluid connection with the first port of the first battery pack and a second exterior port in fluid connection with the second port of the second battery pack.

20. The machine of claim 18, wherein the first battery pack includes an exit port positioned in the exterior surface of the first battery pack housing, and wherein the exit port is in fluid connection with the second port of the second battery pack.
